(19) United States
(12) Patent Application Publication
(10) Pub. No.: US 2021/0249659 A1
(43) Pub. Date: Aug. 12, 2021

(54) BATTERY AND DEVICE INCLUDING THE SAME

(71) Applicant: Ningde Amperex Technology Limited, Ningde (CN)

(72) Inventor: Jie Liu, Ningde (CN)

(21) Appl. No.: 16/883,900

(22) Filed: May 26, 2020

(30) Foreign Application Priority Data
Feb. 11, 2020 (CN) 202010094034.7

(51) Int. Cl. H01M 4/58; H01M 2/16; H01M 4/485; H01M 4/64

(52) U.S. Cl. CPC H01M 4/5825; H01M 2/1673; H01M 2004/021; H01M 4/64; H01M 4/485

(57) ABSTRACT

A battery includes a positive electrode plate and an electrolyte. The positive electrode plate includes a positive electrode current collector, a first positive electrode material layer, and a second positive electrode material layer. The first positive electrode material layer is sandwiched between the positive electrode current collector and the second positive electrode material layer, or the second positive electrode material layer is sandwiched between the positive electrode current collector and the first positive electrode material layer. The first positive electrode material layer includes first active material particles, the second electrode material layer includes second active material particles having an average particle size larger than an average particle size of the first active material particles. A ratio of a thickness T (μm) of the first positive electrode material layer to a viscosity V (mPa*S) of the electrolyte is 1:0.5˜1:5.

### FIELD

The subject matter herein generally relates to a battery and a device including the same.

### BACKGROUND

In recent years, with a rapid development of mobile devices, electric vehicles, and smart grids, high energy density batteries have received a lot of attention and research. Temperature is an important factor regarding battery capacity. For example, a low temperature environment will reduce the performance of a battery as compared to that in a room temperature environment.

### SUMMARY

A battery having a high volume energy density while maintaining performances in a low temperature environment is disclosed.

A battery includes a positive electrode plate and an electrolyte. The positive electrode plate includes a first positive electrode current collector, a first positive electrode material layer including first active material particles, and a second positive electrode material layer including second active material particles having an average particle size larger than an average particle size of the first active material particles. The first positive electrode material layer is sandwiched between the positive electrode current collector and the second positive electrode material layer. A ratio of a thickness T (μ) of the first positive electrode material layer to a viscosity V (mPa*S) of the electrolyte is 1:0.5˜1:5.

Furthermore, the ratio of the thickness T (μm) of the first positive electrode material layer to the viscosity V (mPa*S) of the electrolyte is 1:0.5˜1:2.

Furthermore, 90% of the first active particles have an average particle size of 20 μm or less.

Furthermore, the thickness of the first positive electrode material layer is in a range between 1 μm and 10 μm.

Furthermore, at least one of the first active material particles and the second active material particles is selected from a group consisting of lithium cobaltate, lithium iron phosphate, sodium iron phosphate, lithium vanadium phosphate, sodium vanadium phosphate, lithium vanadyl phosphate, sodium vanadyl phosphate, lithium nickelate, lithium manganate, lithium nickel cobalt aluminate, lithium titanate, lithium nickel cobalt manganate, and any combination thereof.

Furthermore, a material of the first active material particles is the same as a material of the second active material particles.

Furthermore, the positive electrode plate further includes a coating layer, when the first positive electrode material layer is sandwiched between the positive electrode current collector and the second positive electrode material layer, the coating layer is on a surface of the second positive electrode material layer away from the first positive electrode material layer.

Furthermore, the coating layer includes at least one of lithium iron phosphate and aluminum oxide.

Furthermore, the battery further includes a negative electrode plate and a separator, the separator is sandwiched between the negative electrode plate and the positive electrode plate.

Furthermore, the negative electrode plate includes a negative electrode current collector, a first negative electrode material layer, and a second negative electrode material layer. The first negative electrode material layer is sandwiched between the negative current collector and the second negative electrode material layer. The first negative electrode material layer includes third active material particles, the second negative electrode material layer includes fourth active material particles having an average particle size larger than an average particle size of the third active material particles.

A battery includes a positive electrode plate and an electrolyte. The positive electrode plate includes a first positive electrode current collector, a first positive electrode material layer including first active material particles, and a second positive electrode material layer including second active material particles having an average particle size larger than an average particle size of the first active material particles. The second positive electrode material layer is sandwiched between the positive electrode current collector and the first positive electrode material layer. A ratio of a thickness T (μm) of the first positive electrode material layer to a viscosity V (mPa*S) of the electrolyte is 1:0.5˜1:5.

Furthermore, the ratio of the thickness T (μm) of the first positive electrode material layer to the viscosity V (mPa*S) of the electrolyte is 1:0.5˜1:2.

Furthermore, 90% of the first active particles have an average particle size of 20 μm or less.

Furthermore, the thickness of the first positive electrode material layer is in a range between 1 μm and 10 μm.

Furthermore, at least one of the first active material particles and the second active material particles is selected from a group consisting of lithium cobaltate, lithium iron phosphate, sodium iron phosphate, lithium vanadium phosphate, sodium vanadium phosphate, lithium vanadyl phosphate, sodium vanadyl phosphate, lithium nickelate, lithium manganate, lithium nickel cobalt aluminate, lithium titanate, lithium nickel cobalt manganate, and any combination thereof.

Furthermore, a material of the first active material particles is the same as a material of the second active material particles.

Furthermore, the positive electrode plate further includes a coating layer, when the first positive electrode material layer is sandwiched between the positive electrode current collector and the second positive electrode material layer, the coating layer is on a surface of the second positive electrode material layer away from the first positive electrode material layer.

Furthermore, the coating layer includes at least one of lithium iron phosphate and aluminum oxide.

Furthermore, the battery further includes a negative electrode plate and a separator, the separator is sandwiched between the negative electrode plate and the positive electrode plate.

Furthermore, the negative electrode plate includes a negative electrode current collector, a first negative electrode material layer, and a second negative electrode material layer. The first negative electrode material layer is sandwiched between the negative current collector and the second negative electrode material layer, or the second negative electrode material layer is sandwiched between the negative electrode current collector and the first negative electrode material layer. The first negative electrode material layer includes third active material particles, the second negative electrode material layer includes fourth active material particles having an average particle size larger than an average particle size of the third active material particles.

In the battery of the present disclosure, when the positive electrode plate includes a double-layer structure, that is the positive electrode plate includes the large second active material particles, a compaction density of the positive electrode plate can be ensured, thereby further ensuring a volume energy density of the battery. In addition, by applying the small first active material particles, the positive electrode plate can maintain a high ion transmission rate at low temperatures, improving a low temperature capacity performance of the battery. In addition, when the ratio of the ratio of the thickness T (μm) of the first positive electrode material layer to the viscosity V (mPa*S) of the electrolyte 20 is 1:0.5˜1:5, the volume energy density of the assembled battery is 700 Wh/L, or more, the low temperature discharge capacity retention rate of the assembled battery is 30% or more when discharged to 3.4 V, and a cycle number of the assembled battery is 1,000 times or more when the capacity is maintained above 80%.

### BRIEF DESCRIPTION OF THE DRAWINGS

FIG. 1 is a cross-sectional view of part of a battery in one embodiment according to the present disclosure.

FIG. 2 is a cross-sectional view of a positive electrode plate in the battery of FIG. 1.

FIG. 3 is a cross-sectional view of part of a positive electrode plate in another embodiment according to the present disclosure.

FIG. 4 is a cross-sectional view of a negative electrode plate in the battery of FIG. 1.

### DETAILED DESCRIPTION

In order to understand the above objectives, features and advantages of the present disclosure more clearly, the present disclosure will be further described in detail below in conjunction with the accompanying drawings and specific embodiments. It should be noted that the embodiments of the present application and features in the embodiments can be combined with each other without conflicts. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein, but are not to be considered as limiting the scope of the embodiments. The term “and/or” as used herein includes all and any combination of one or more of the associated listed items. The term “connected” is defined as connected, whether directly or indirectly through intervening components, and is not necessarily limited to physical connections. As used herein, terms ‘up’, “down”, “above”, “below”, “left”, “right”, and similar expressions are only for illustrative purposes.

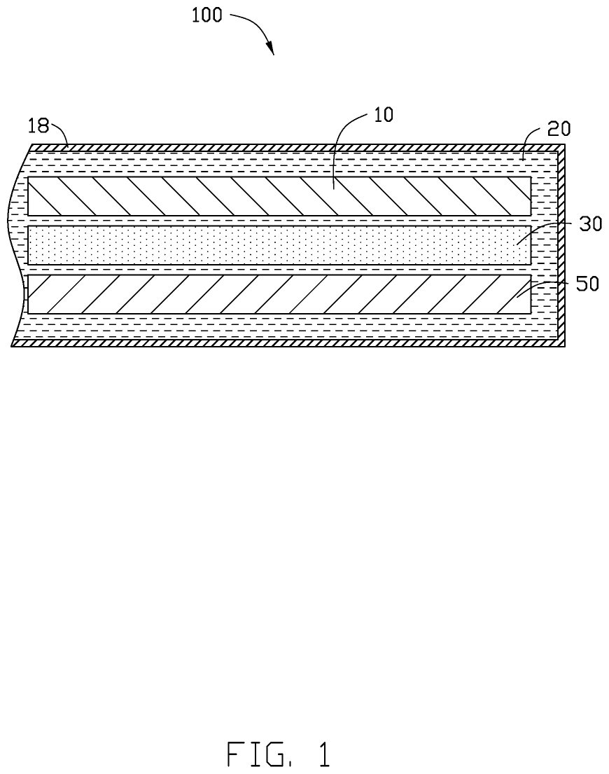

FIG. 1 illustrates an embodiment of a battery 100 including a positive electrode plate 10, a separator 30, and a negative electrode plate 50. The positive electrode plate, the separator 30, and the negative electrode plate 50 are received in a housing 18. The battery 100 may be a secondary battery, such as a lithium-ion battery, a sodium-ion battery, or the like.

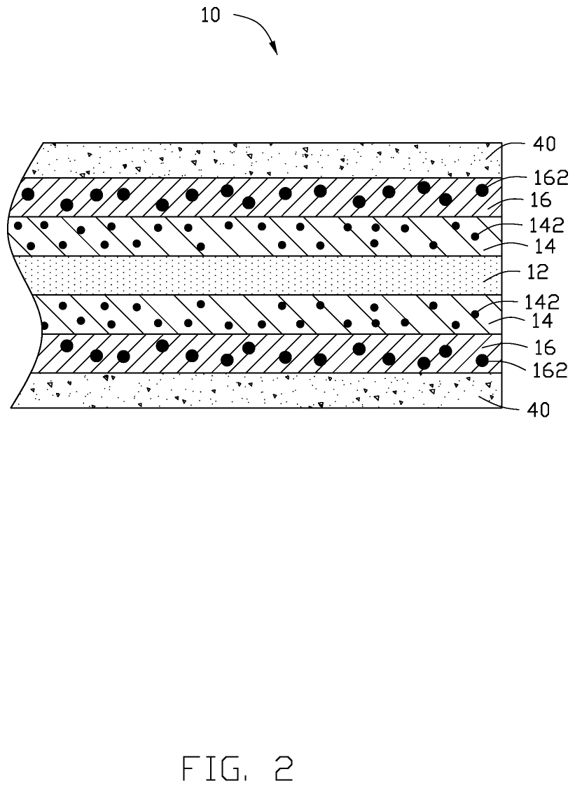

FIG. 2 illustrates that the positive electrode plate 10 includes a positive electrode current collector 12, a first positive electrode material layer 14, and a second positive electrode material layer 16. The first positive electrode material layer 14 is sandwiched between the positive electrode current collector 12 and the second positive electrode material layer 16. The first positive electrode material layer 14 includes first active material particles 142, the second positive electrode material layer 16 includes second active material particles 162, and an average particle size of the first active material particles 142 is smaller than that of the second active material particles 162. A thickness of the first positive electrode material layer 14 is T. In one embodiment, the average particle size refers to a particle size which reaches a certain proportion of a cumulative volume from a side of small particle in a granularity distribution on a volume basis.

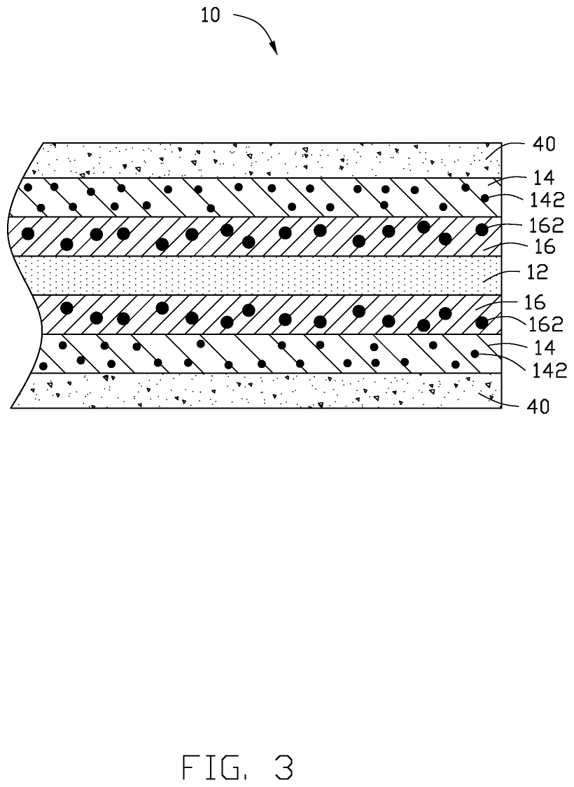

Referring to FIG. 3, in another embodiment, a position of the first positive electrode material layer 14 and a position of the second positive electrode material layer 16 are interchangeable, that is, the second positive electrode material layer 16 can be sandwiched between the positive electrode current collector 12 and the first positive electrode material layer 14. The average particle size of the first active material particles 142 is smaller than that of the second active material particles 162.

The battery 100 further includes an electrolyte 20 having a viscosity of V. A ratio of a thickness T (μm) of the first positive electrode material layer 14 to a viscosity V (mPa*S) of the electrolyte 20 is 1:0.5˜1:5.

Any decrease in capacity of the battery 100 in a low temperature environment is mainly related to a greater polarization of the battery 100, and this polarization is more obvious on the positive electrode plate 10. To solve low capacity of the battery 100 at a low temperature, an average particle size of the positive electrode material of the positive electrode plate 10 can be reduced or a coating weight of the positive electrode material can be reduced. Decreasing the average particle size of the positive electrode material decreases a bulk density and a compaction density of the positive electrode material. Therefore, if a same total capacity is to be reached, a thickness of an actual positive electrode plate 10 must be increased, thereby reducing a volume energy density of the battery 100. If a coating weight is reduced, a coating length of the positive electrode plate 10 needs to be increased. Increasing the coating length of the positive electrode plate 10 increases a proportion of inactive materials such as the housing 18 and the separator 30 increases, therefore a volume energy density of the battery 100 decreases accordingly.

Normally, the compaction density of the positive electrode plate 10 is much higher than that of the negative electrode plate 50, and the coating weight of the positive electrode plate 10 is also higher than that of the negative electrode plate 50 (for example, it can be twice the negative electrode plate 50), resulting in a lower porosity of the positive electrode plate 10, and reduced a transmission rate of ions at low temperature. At the same time, the high-viscosity electrolyte 20 does not easily enter the positive electrode plate 10 at a low temperature, which results in depressed replenishment of the positive electrode plate 10 by the electrolyte 20, thereby further increasing an impedance of the battery 100. To increase the capacity of the battery 100 at a low temperature, the polarization of the battery 100 must be reduced, especially the polarization of the positive electrode plate 10, and the viscosity V of the electrolyte 20 must be reduced at the same time.

In the present disclosure, by applying the second active material particles 162 of a large size, the compaction density of the positive electrode plate 10 can be ensured, thereby further ensuring the volume energy density of the battery 100. In addition, by applying first active material particles 142 of a small size, the positive electrode plate 10 can maintain a high ion transmission rate at low temperatures, thereby improving a low temperature capacity performance of the battery 100.

However, the first positive electrode material layer 14 having relatively small particles will cause the battery 100 to consume more electrolyte 20 during charging and discharging processes, and therefore it is necessary to increase a replenishment speed of the electrolyte 20 in the positive electrode plate 10. In particular, the thicker the thickness T of the first positive electrode material layer 14, the more are the amount and the replenishment speed of the electrolyte 20 required. Thus, the thickness T of the first positive electrode material layer 14 and the viscosity V of the electrolyte 20 must be limited.

Alternatively, the ratio of the thickness T (μm) of the first positive electrode material layer 14 to the viscosity V (mPa*S) of the electrolyte 20 is 1:0.5˜1:2.

Since the average particle size of the first active material particles 142 is smaller than the average particle size of the second active material particles 162, the compaction density of the first positive electrode material layer 14 is smaller than the compaction density of the second positive material layer 16.

The average particle size of the first active material particles 142 affects a transmission distance of the ions (such as lithium ions) in the first positive electrode material layer 14 during the charging and discharging processes of the battery 100, and further affects the capacity of the battery 100 in a low temperature environment. Therefore, the average particle size D90 of the first active material particles 142 is 20 μm or less, that is, 90% of the first active material particles have an average particle size of 20 μm or less. Specifically, the first active material particles 142 are dispersed in a dispersant (a surfactant such as ethanol or acetone), and a dispersion solution is obtained by ultrasonic treatment for 30 minutes, the dispersion solution is added into a Malvern Mastersizer for testing, and a volume distribution test result is obtained.

The thickness T of the first positive electrode material layer 14 also satisfies the following formula: 1 μm≤T≤10 μm. The thickness T of the first positive electrode material layer 14 can be measured by a scanning electron microscope (SEM). Since the positive electrode plate 10 is made by cold pressing, second active material particles 162 of the second positive electrode material layer 16 are inevitably embedded in the first positive electrode material layer 14. The thickness T of the first positive electrode material layer 14 is calculated based on a portion where second active material particles 162 are not embedded in the first positive electrode material layer 14.

In this embodiment, each of the first positive electrode material layer 14 and the second positive electrode material layer 16 further includes a conductive agent and a binder.

Each of the first active material particles 142 and the second active material particles 162 may be selected from a group consisting of lithium cobaltate, lithium iron phosphate, sodium iron phosphate, lithium vanadium phosphate, sodium vanadium phosphate, lithium vanadyl phosphate, sodium vanadyl phosphate, lithium nickelate, lithium manganate, lithium nickel cobalt aluminate, lithium titanate, lithium nickel cobalt manganate, and any combination thereof. The average particle size of the first active material particles 142 constituting the first positive electrode material layer 14 and the average particle size of the second active material particles 162 constituting the second positive electrode material layer 16 are distinguished by an electron scanning microscope.

Alternatively, material of the first active material particles 142 is the same as material of the second active material particles 162.

The positive electrode plate 10 further includes a coating layer 40. The second positive electrode material layer 16 is sandwiched between the first positive electrode material layer 14 and the coating layer 40, that is, the coating layer 40 is disposed on a surface of the second positive electrode material layers 16 away from the first positive electrode material layer 14. The coating layer 40 includes at least one of lithium iron phosphate and aluminum oxide. During the charging and discharging processes of the positive electrode plate 10, the coating layer 40 improves a thermal stability of the structures of the first positive electrode material layer 14 and the second positive electrode material layer 16, thereby improving safety of the battery 100.

FIG. 1 illustrates that the separator 30 is sandwiched between the negative electrode plate 50 and the positive electrode plate 10. The positive electrode plate 10, the separator 30, and the negative electrode plate 50 are wound together to form a battery cell of the battery 100. The electrolyte 20 infiltrates into the negative electrode plate 50, the separator 30, and the positive electrode plate 10.

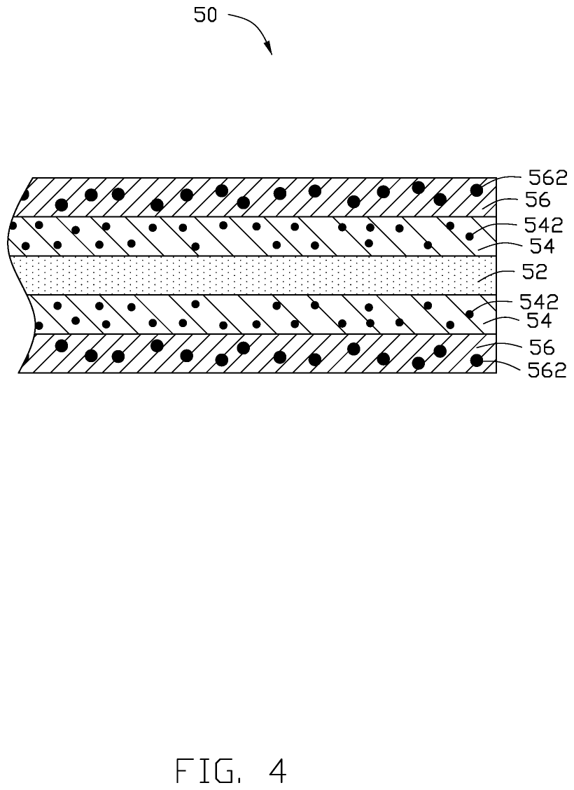

FIG. 4 illustrates that the negative electrode plate 50 includes a negative electrode current collector 52, a first negative electrode material layer 54, and a second negative electrode material layer 56. The first negative electrode material layer 54 is sandwiched between the negative electrode current collector 52 and the second negative electrode material layer 56, or the second negative electrode material layer 56 is sandwiched between the negative electrode current collector 52 and the first negative electrode material layer 54. The first negative electrode material layer 54 includes third active material particles 542, the second negative electrode material layer 56 includes fourth active material particles 562, an average particle size of the third active material particle 542 is smaller than an average particle size of the fourth active material particle 562.

The present disclosure is illustrated by way of different examples and comparative examples.

### Example 1

An aluminum foil was used as the positive electrode current collector 12. A lithium cobaltate slurry of small particles was evenly coated on a surface of the aluminum foil as the first positive electrode material layer 14. That is, the first positive electrode active material particles were lithium cobaltate. The lithium cobaltate slurry of small particles was composed of 95.6 wt % lithium cobaltate (an average particle size D90=3 μm), 3.0 wt % polyvinylidene fluoride, and 1.4 wt % conductive carbon black. The thickness T of the first positive electrode material layer 14 was 3 μm. Then a lithium cobaltate slurry of large particles was coated on the first positive electrode material layer 14 as the second positive electrode material layer 16. The lithium cobaltate slurry of large particles was composed of 97.0 wt % lithium cobaltate (an average particle size D50 being 13 μm, an average particle size D90 being 50 μm), 1.6 wt % polyvinylidene fluoride, and 1.4 wt % conductive carbon black. After coating, drying, and cold pressing, a positive electrode plate 10 was obtained.

A copper foil was used as the negative electrode current collector 52, a surface of the copper foil was coated with a graphite slurry, which was composed of 97.5 wt % artificial graphite, 1.3 wt % carboxymethyl cellulose, and 1.2 wt % styrene-butadiene rubber, then followed by cold pressing to obtain a negative electrode plate 50.

The positive electrode plate 10 and the negative electrode plate 50 were wound, and the positive electrode plate 10 and the negative electrode plate 50 were separated by a polyethylene (PE) separator 30, to obtain a bare wound cell. The bare cell was to be filled with electrolyte after top side sealing, spray coding, and vacuum drying.

A certain proportion of a solvent was mixed in a nitrogen atmosphere, and a lithium salt and additives were added to prepare an electrolyte 20 having a viscosity V of 4.5 mPa*S. That is, the ratio of the thickness T (μm) of the first positive electrode material layer 14 to the viscosity V (mPa*S) of the electrolyte 20 was 1:1.5. A certain amount of the electrolyte 20 was injected into the bare cell under a vacuum environment, then sealing after being rested for 30 minutes in a vacuum, and then placing in a high-temperature environment, followed by formatting and capacity treatment, to obtain an activated battery. 100.

### Example 2

The preparation method was the same as that of example 1, except that the first active material particles 142 were nickel cobalt manganate in this example 2.

### Example 3

The preparation method was the same as that of example 1, except that the first active material particles 142 were lithium manganate in this example 3.

### Example 4

The preparation method was the same as that of example 1, except that the first active material particles 142 were lithium iron phosphate in this example 4.

### Example 5

The preparation method was the same as that of example 1, except that the first active material particles 142 were nickel cobalt aluminate in this example 5.

### Example 6

The preparation method was the same as that of example 1, except that the first active material particles 142 were lithium titanate in this example 6.

### Comparative Example 1

An aluminum foil was used as the positive electrode current collector 12, a surface of the aluminum foil was coated with a lithium cobaltate slurry, which was composed of 97.0 wt % lithium cobaltate (LiCoO₂, an average particle size D90 of 3 μm, and an average particle size D90 of 50 μm), 1.6 wt % polyvinylidene fluoride, and 1.4 wt % conductive carbon black, then followed by cold pressing to obtain a positive electrode plate 10.

A copper foil was used as the negative electrode current collector 52, a surface of the copper foil was coated with a graphite slurry, which was composed of 97.5 wt % artificial graphite, 1.3 wt % carboxymethyl cellulose (CMC), and 1.2 wt % styrene-butadiene rubber (SBR), then followed by cold pressing to obtain a negative electrode plate 50.

The positive electrode plate 10 and the negative electrode plate 50 were wound, and the positive electrode plate 10 and the negative electrode plate 50 were separated by a PE separator 30, to obtain a bare wound cell. The bare cell was to be filled with electrolyte after top side sealing, spray coding, and vacuum drying.

A certain proportion of a solvent was mixed in a nitrogen atmosphere, and a lithium salt and additives were added to prepare an electrolyte 20 having a viscosity V of 4.5 mPa*S. A certain amount of the electrolyte 20 was injected into the bare cell under a vacuum environment, then sealed after being rested for 30 minutes in a vacuum, and then placed in a high-temperature environment, followed by formatting and capacity treatment, to obtain an activated battery. 100.

### Comparative Example 2

The preparation method was the same as that of comparative example 1, except that the average particle size D90 of lithium cobaltate in the lithium cobaltate slurry was 3 μm in this comparative example 2.

Battery capacity, low temperature performance, and cycle performance were all tested in the batteries of examples 1-6 and comparative examples 1-2.

Method for Testing Battery Capacity as Follows

The battery 100 was placed in a room temperature (25±3° C.) for 30 minutes, was charged to 4.4V at a constant current of 0.5 C, then charged to 0.05 C at such constant voltage, rested for 30 minutes, and discharged to 3V at a constant current of 0.2 C, and rested for 30 minutes. The discharge voltage was recorded as an actual capacity of the battery 100 at room temperature. A thickness, a width, and a length of the battery 100 were tested to convert or associate the actual capacity into or with a volume energy density.

Method for Testing Low Temperature Performance of the Battery 100 as Follows

Ten batteries 100 were placed in the room temperature for 120 minutes, then charged to 4.4V at a constant current of 0.5 C, and charged to 0.05 C at such constant voltage, the batteries were fully charged. Then the batteries 100 were placed in a high-low temperature chamber at −20° C. for 120 minutes, and discharged to 3.4V at a constant current of 0.2 C. An average value of the discharge capacities of ten batteries 100 was taken as a low temperature discharge capacity of the battery 100. A ratio of the low temperature discharge capacity to the volume energy density of the battery at the room temperature was a low temperature discharge capacity retention rate of the battery 100.

Method for Testing Cycle Performance of the Battery 100 as Follows

The battery 100 was placed in the room temperature for 120 minutes, then charged to 4.4V at a constant current of 1 C, charged to 0.05 C at such constant voltage, rested for 5 minutes, discharged to 3V at a constant current of 1 C, rested for 5 minutes, and further charged to 4.4V at a constant current of 1 C, charged to 0.05 C at such constant voltage, rested for 5 minutes, discharged to 3V at a constant current of 1 C, rested for 5 minutes, this charge-discharge cycle was repeated until a discharge capacity of a battery cell reaches 80% of a first discharge capacity of the battery cell, then the test was stopped, and the cycle number at this time was recorded as the cycle performance data of the battery 100.

Table 1 shows the main different conditions and the results of electrochemical performance tests of examples 1-6 and comparative examples 1-2.

TABLE 1

| | Whether | | Volume | Low temperature | Number of |
|---|---|---|---|---|---|
| | there is a | | energy | discharge | cycles when |
| | double-layer | Active | density | capacity | capacity |
| | structure | material | (Wh/L) | retention rate | decays to 80% |
| Example 1 | Yes | lithium | 742 | 57.80% | 1134 |
| | | cobaltate | | | |
| Example 2 | Yes | nickel | 736 | 52.70% | 1128 |
| | | cobalt | | | |
| | | manganate | | | |
| Example 3 | Yes | lithium | 733 | 48.80% | 1122 |
| | | manganate | | | |
| Example 4 | Yes | lithium | 729 | 50.70% | 1126 |
| | | iron | | | |
| | | phosphate | | | |
| Example 5 | Yes | nickel | 735 | 42.70% | 1117 |
| | | cobalt | | | |
| | | aluminate | | | |
| Example 6 | Yes | lithium | 732 | 53.90% | 1134 |
| | | titanate | | | |
| Comparative | No | lithium | 750 | 25.40% | 1143 |
| example 1 | | cobaltate | | | |
| Comparative | No | lithium | 688 | 36.80% | 897 |
| example 2 | | cobaltate | | | |

As can be seen from the results in table 1, compared with the battery assembled with a positive electrode plate including a single-layer structure, the low temperature discharge capacity of the battery 100 assembled with the positive electrode plate 10 including a double-layer structure significantly increases while maintaining the volume energy density of the battery 100 at room temperature.

### Example 7

The preparation method was the same as that of example 2, except that the thickness T of the first positive electrode material layer 14 was 1 μm and a viscosity V of the electrolyte 20 was 1.5 mPa*S in this example 7.

### Example 8

The preparation method was the same as that of example 2, except that the thickness T of the first positive electrode material layer 14 was 5 μm and a viscosity V of the electrolyte 20 was 7.5 mPa*S in this example 8.

### Example 9

The preparation method was the same as that of example 2, except that the thickness T of the first positive electrode material layer 14 was 7 μm and a viscosity V of the electrolyte 20 was 10.5 mPa*S in this example 9.

### Example 10

The preparation method was the same as that of example 2, except that the thickness T of the first positive electrode material layer 14 was 10 μm and a viscosity V of the electrolyte 20 was 15 mPa*S in this example 10.

### Comparative Example 3

The preparation method was the same as that of example 2, except that the thickness T of the first positive electrode material layer 14 was 0.5 μm in this comparative example 3.

### Comparative Example 4

The preparation method was the same as that of example 2, except that the thickness T of the first positive electrode material layer 14 was 15 μm in this comparative example 4.

Battery capacity, low temperature performance, and cycle performance were all tested in the batteries 100 of examples 2 and 7-10 and comparative examples 3-4 by the above testing methods. Results are shown in Table 2.

TABLE 2

| | Thickness of | | Low | |
|---|---|---|---|---|
| | first positive | Volume | temperature | Number of |
| | electrode | energy | discharge | cycles when |
| | material layer | density | capacity | capacity |
| | (μm) | (Wh/L) | retention rate | decays to 80% |
| Example 7 | 1 | 744 | 38.30% | 1132 |
| Example 2 | 3 | 736 | 52.70% | 1128 |
| Example 8 | 5 | 729 | 57.20% | 1107 |
| Example 9 | 7 | 718 | 62.10% | 1074 |
| Example 10 | 10 | 702 | 68.90% | 1039 |
| Comparative | 0.5 | 747 | 27.60% | 1139 |
| example 3 | | | | |
| Comparative | 15 | 678 | 72.10% | 1002 |
| example 4 | | | | |

As can be seen from table 2, with an increase of the thickness T of the first positive electrode material layer 14, the low temperature capacity of the battery 100 increases, and both the volume energy density and the cycle performance decrease. If the thickness T of the first positive electrode material layer 14 is very thick (greater than 10 μm), the thickness of the positive electrode plate 10 will be affected, thereby reducing the volume energy density of the battery 100. If the thickness T of the first positive electrode material layer 14 is very thin (less than 1 μm), the capacity of the first positive electrode material layer 14 is limited, so limiting the capacity of the battery 100 in a low temperature environment.

### Example 11

The preparation method was the same as that of example 2, except that the average particle size D90 of the first positive electrode active material particles was 1 μm in this example 11.

### Example 12

The preparation method was the same as that of example 2, except that the average particle size D90 of the first positive electrode active material particles was 5 μm in this example 12.

### Example 13

The preparation method was the same as that of example 2, except that the average particle size D90 of the first positive electrode active material particles was 10 μm in this example 13.

### Example 14

The preparation method was the same as that of example 2, except that the average particle size D90 of the first positive electrode active material particles was 15 μm in this example 14.

### Example 15

The preparation method was the same as that of example 2, except that the average particle size D90 of the first positive electrode active material particles was 20 μm in this example 15.

### Comparative Example 5

The preparation method was the same as that of example 2, except that the average particle size D90 of the first positive electrode active material particles was 25 μm in this comparative example 5.

Battery capacity, low temperature performance, and cycle performance were all tested in the batteries 100 of examples 2 and 11-15 and comparative example 5 by the above testing methods. Results are shown in Table 3.

TABLE 3

| | Particle size | | | |
|---|---|---|---|---|
| | D90 of first | | Low | |
| | positive | Volume | temperature | Number of |
| | electrode | energy | discharge | cycles when |
| | active material | density | capacity | capacity |
| | particles | (Wh/L) | retention rate | decays to 80% |
| Example 11 | 1 | 736 | 68.70% | 1143 |
| Example 2 | 3 | 736 | 52.70% | 1128 |
| Example 12 | 5 | 736 | 48.60% | 1122 |
| Example 13 | 10 | 736 | 43.30% | 1106 |
| Example 14 | 15 | 736 | 38.50% | 1098 |
| Example 15 | 20 | 736 | 32.70% | 1067 |
| Comparative | 25 | 736 | 28.30% | 1033 |
| example 5 | | | | |

As can be seen from table 3, with a decrease of the average particle size of the first positive electrode active material particles, the low temperature discharge performance of the battery is improved. This is because that the average particle size of the first active material particles 142 affects transmission distances of ions in the first positive electrode material layer 14 during the charging and discharging processes of the battery 100, and further affects the capacity of the battery 100 in a low temperature environment. If the average particle size of the first active material particles 142 is too large, the transmission rate of ions is reduced, thereby lowering the low temperature capacity performance of the battery 100.

### Example 16

The preparation method was the same as that of example 2, except that the viscosity V of the electrolyte 20 was 1.5 mPa*S, the ratio of the thickness T (μm) to the viscosity V (mPa*S) was 1:0.5 in this example 16.

### Example 17

The preparation method was the same as that of example 2, except that the viscosity V of the electrolyte 20 was 3 mPa*S, the ratio of the thickness T (μm) to the viscosity V (mPa*S) was 1:1 in this example 17.

### Example 18

The preparation method was the same as that of example 2, except that the viscosity V of the electrolyte 20 was 6 mPa*S, the ratio of the thickness T (μm) to the viscosity V (mPa*S) was 1:2 in this example 18.

### Example 19

The preparation method was the same as that of example 2, except that the viscosity V of the electrolyte 20 was 12 mPa*S, the ratio of the thickness T (μm) to the viscosity V (mPa*S) was 1:4 in this example 19.

### Example 20

The preparation method was the same as that of example 2, except that the viscosity V of the electrolyte 20 was 15 mPa*S, the ratio of the thickness T (μm) to the viscosity V (mPa*S) was 1:5 in this example 20.

### Comparative Example 6

The preparation method was the same as that of example 2, except that the viscosity V of the electrolyte 20 was 18 mPa*S, and the ratio of the thickness T (μm) to the viscosity V (mPa*S) was 1:6 in this comparative example 6.

### Comparative Example 7

The preparation method was the same as that of example 2, except that the viscosity V of the electrolyte 20 was 1.2 mPa*S, the ratio of the thickness T (μm) to the viscosity V (mPa*S) was 1:0.4 in this comparative example 7.

Battery capacity, low temperature performance, and cycle performance were all tested in the batteries 100 of examples 2 and 10-20 and comparative examples 6-7 by the above testing methods. Results are shown in Table 4.

TABLE 4

| | | | Low | |
|---|---|---|---|---|
| | Ration of | Volume | temperature | Number of |
| | thickness T | energy | discharge | cycles |
| | to viscosity | density | capacity | when capacity |
| | V (μm:mPa*S) | (Wh/L) | retention rate | decays to 80% |
| Example 16 | 1:0.5 | 736 | 69.70% | 1153 |
| Example 17 | 1:1 | 736 | 58.90% | 1146 |
| Example 2 | 1:1.5 | 736 | 52.70% | 1128 |
| Example 18 | 1:2 | 736 | 45.70% | 1105 |
| Example 19 | 1:4 | 736 | 37.40% | 1036 |
| Example 20 | 1:5 | 736 | 30.70% | 1007 |
| Comparative | 1:6 | 736 | 22.10% | 879 |
| example 6 | | | | |
| Comparative | 1:0.4 | 736 | 23.50% | 1160 |
| example 7 | | | | |

As can be seen from table 4, with an increase of the ratio of the thickness T to the viscosity V of the electrolyte 20, the low temperature performance of the battery increases, and the cycle performance of the battery also increases.

The higher the ratio of T:V, the lower is the viscosity V of the electrolyte 20 relative to the thickness T of the first positive electrode material layer 14. So that infiltration of and supplementing the positive electrode plate 10 with the electrolyte 20 is better, and the cycle performance and a low voltage capacity of the battery is better. However, when the ratio of T:V exceeds 1:0.5, indicating that the viscosity V of the electrolyte 20 relative to the thickness T of the first positive electrode material layer 14 is higher, the electrolyte 20 cannot be replenished quickly during the charging and discharging processes of the battery 100, resulting in poor low voltage capacity and cycle performance of the battery 100.

In the battery 100 of the present disclosure, when the positive electrode plate 10 includes a double-layer structure, that is the positive electrode plate 10 includes the second active material particles 162 of a large size, the compaction density of the positive electrode plate 10 can be ensured, thereby further ensuring the volume energy density of the battery 100. In addition, by applying first active material particles 142 of a small size, the positive electrode plate 10 can maintain a high ion transmission rate at low temperatures, thereby improving a low temperature capacity performance of the battery 100. In addition, when the ratio of the ratio of the thickness T (μm) of the first positive electrode material layer 14 to the viscosity V (mPa*S) of the electrolyte 20 is 1:0.5˜1:5, the volume energy density of the assembled battery 100 is 700 Wh/L, or more. Further, the low temperature discharge capacity retention rate of the assembled battery 100 is 30% or more when discharged to 3.4 V, and the cycle number of the assembled battery 100 is 1,000 or more times when the capacity is maintained above 80%.

A device includes the battery 100 of the present disclosure could be such as cellphone, laptop or electric car. The battery 100 is used to provide energy for the device.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A battery comprising:
a positive electrode plate comprising:
a positive electrode current collector,
a first positive electrode material layer comprising first active material particles, and
a second positive electrode material layer comprising second active material particles having an average particle size larger than an average particle size of the first active material particles, the first positive electrode material layer being sandwiched between the positive electrode current collector and the second positive electrode material layer; and
an electrolyte;
wherein a ratio of a thickness T (μm) of the first positive electrode material layer to a viscosity V (mPa*S) of the electrolyte is 1:0.5˜1:5.

2. The battery of claim 1, wherein the ratio of the thickness T (μm) of the first positive electrode material layer to the viscosity V (mPa*S) of the electrolyte is 1:0.5˜1:2.

3. The battery of claim 1, wherein 90% of the first active particles have an average particle size of 20 μm or less.

4. The battery of claim 1, wherein the thickness of the first positive electrode material layer is in a range between 1 μm and 10 μm.

5. The battery of claim 1, wherein at least one of the first active material particles and the second active material particles is selected from a group consisting of lithium cobaltate, lithium iron phosphate, sodium iron phosphate, lithium vanadium phosphate, sodium vanadium phosphate, lithium vanadyl phosphate, sodium vanadyl phosphate, lithium nickelate, lithium manganate, lithium nickel cobalt aluminate, lithium titanate, lithium nickel cobalt manganate, and any combination thereof.

6. The battery of claim 5, wherein a material of the first active material particles is the same as a material of the second active material particles.

7. The battery of claim 1, wherein the positive electrode plate further comprises a coating layer, when the first positive electrode material layer is sandwiched between the positive electrode current collector and the second positive electrode material layer, the coating layer is on a surface of the second positive electrode material layer away from the first positive electrode material layer.

8. The battery of claim 7, wherein the coating layer comprises at least one of lithium iron phosphate and aluminum oxide.

9. The battery of claim 1, further comprising a negative electrode plate and a separator, the separator being sandwiched between the negative electrode plate and the positive electrode plate.

10. The battery of claim 9, wherein the negative electrode plate comprises a negative electrode current collector, a first negative electrode material layer, and a second negative electrode material layer, the first negative electrode material layer is sandwiched between the negative current collector and the second negative electrode material layer, the first negative electrode material layer comprises third active material particles, and the second negative electrode material layer comprise fourth active material particles having an average particle size larger than an average particle size of the third active material particles.

11. A battery comprising:
a positive electrode plate comprising:
a positive electrode current collector,
a first positive electrode material layer comprising first active material particles, and
a second positive electrode material layer comprising second active material particles having an average particle size larger than an average particle size of the first active material particles, the second positive electrode material layer being sandwiched between the positive electrode current collector and the first positive electrode material layer; and
an electrolyte;
wherein a ratio of a thickness T (μm) of the first positive electrode material layer to a viscosity V (mPa*S) of the electrolyte is 1:0.5˜1:5.

12. The battery of claim 11, wherein the ratio of the thickness T (μm) of the first positive electrode material layer to the viscosity V (mPa*S) of the electrolyte is 1:0.5˜1:2.

13. The battery of claim 11, wherein 90% of the first active particles have an average particle size of 20 μm or less.

14. The battery of claim 11, wherein the thickness of the first positive electrode material layer is in a range between 1 μm and 10 μm.

15. The battery of claim 11, wherein at least one of the first active material particles and the second active material particles is selected from a group consisting of lithium cobaltate, lithium iron phosphate, sodium iron phosphate, lithium vanadium phosphate, sodium vanadium phosphate, lithium vanadyl phosphate, sodium vanadyl phosphate, lithium nickelate, lithium manganate, lithium nickel cobalt aluminate, lithium titanate, lithium nickel cobalt manganate, and any combination thereof.

16. The battery of claim 11, wherein the positive electrode plate further comprises a coating layer, when the first positive electrode material layer is sandwiched between the positive electrode current collector and the second positive electrode material layer, the coating layer is on a surface of the second positive electrode material layer away from the first positive electrode material layer.

17. The battery of claim 16, wherein the coating layer comprises at least one of lithium iron phosphate and aluminum oxide.

18. The battery of claim 11, further comprising a negative electrode plate and a separator, the separator being sandwiched between the negative electrode plate and the positive electrode plate.

19. The battery of claim 18, wherein the negative electrode plate comprises a negative electrode current collector, a first negative electrode material layer, and a second negative electrode material layer, the first negative electrode material layer is sandwiched between the negative current collector and the second negative electrode material layer, the first negative electrode material layer comprises third active material particles, the second negative electrode material layer comprise fourth active material particles having an average particle size larger than an average particle size of the third active material particles.

20. A device comprising
a battery comprising
a positive electrode plate comprising:
a positive electrode current collector,
a first positive electrode material layer comprising first active material particles, and a second positive electrode material layer comprising second active material particles having an average particle size larger than an average particle size of the first active material particles, the first positive electrode material layer being sandwiched between the positive electrode current collector and the second positive electrode material layer, or the second positive electrode material layer being sandwiched between the positive electrode current collector and the first positive electrode material layer; and
an electrolyte;
wherein a ratio of a thickness T (μm) of the first positive electrode material layer to a viscosity V (mPa*S) of the electrolyte is 1:0.5˜1:5.
